(19) United States
(12) Patent Application Publication
(10) Pub. No.: US 2025/0293828 A1
(43) Pub. Date: Sep. 18, 2025

(54) CHANNEL STATE INFORMATION REFERENCE SIGNAL RESOURCE CONFIGURATION AND QUANTIZATION IN TIME-DOMAIN CHANNEL PROPERTY REPORTING

(71) Applicant: ZTE Corporation, Shenzhen (CN)

(72) Inventors: Guangyu JIANG, Shenzhen (CN); Bo GAO, Shenzhen (CN); Minqiang ZOU, Shenzhen (CN); Shujuan ZHANG, Shenzhen (CN)

(21) Appl. No.: 19/221,325

(22) Filed: May 28, 2025

Related U.S. Application Data
(63) Continuation of application No. PCT/CN2023/085730, filed on Mar. 31, 2023.

(51) Int. Cl. H04L 5/00; H04B 7/06

(52) U.S. Cl. CPC H04L 5/0048; H04B 7/0626; H04B 7/06968

(57) ABSTRACT

Systems, methods, and apparatus for wireless communication are described. A wireless communication method includes receiving, by a wireless device, a channel state information (CSI) reporting setting associated with one or more CSI resource settings, where each CSI resource setting of the one or more CSI resource settings includes one CSI reference signal (CSI-RS) resource set, and where the one CSI-RS resource set includes one or more CSI-RS resources. The method further includes receiving, by the wireless device, a CSI triggering state list and determining, by the wireless device, a time-domain channel property (TDCP) based on the CSI reporting setting and the CSI triggering state list. The method further includes sending, by the wireless device, a TDCP report. The described techniques may be adopted by a network device or by a wireless device.

### CROSS-REFERENCE TO RELATED APPLICATION

This application is a continuation and claims priority to International Application No. PCT/CN2023/085730, filed on Mar. 31, 2023, the disclosure of which is hereby incorporated by reference herein in its entirety.

### TECHNICAL FIELD

This patent document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability, and other emerging business needs.

### SUMMARY

Techniques are disclosed for configuring channel state information (CSI) reference signal (CSI-RS) resources and quantizing amplitudes and phases in time-domain channel property (TDCP) reports.

A first example wireless communication method includes receiving, by a wireless device, a channel state information (CSI) reporting setting associated with one or more CSI resource settings, where each CSI resource setting of the one or more CSI resource settings includes one CSI reference signal (CSI-RS) resource set, and where the one CSI-RS resource set includes one or more CSI-RS resources. The method further includes receiving, by the wireless device, a CSI triggering state list and determining, by the wireless device, a time-domain channel property (TDCP) based on the CSI reporting setting and the CSI triggering state list. The method further includes sending, by the wireless device, a TDCP report.

A second example wireless communication method includes receiving, by a wireless device, a higher layer parameter indicating a quantization bitwidth and determining, by the wireless device, an amplitude of channel correlation. The method further includes determining, by the wireless device and based on the amplitude of channel correlation and the quantization bitwidth, an amplitude indicator indicating a quantized amplitude. The method further includes sending, by the wireless device, the amplitude indicator.

A third example wireless communication method includes receiving, by a wireless device, a higher layer signaling including at least one of a phase quantization bitwidth and a quantization mode adaption parameter. The method further includes determining, by the wireless device, a phase of channel correlation. The method further includes determining, by the wireless device and based on the phase of channel correlation and the higher layer signaling, at least one of a phase indicator indicating a quantized phase of channel correlation and a phase quantization mode parameter. The method further includes sending, by the wireless device, at least one of the phase indicator and the phase quantization mode parameter.

A fourth example wireless communication method includes receiving, by a wireless device, a higher layer signaling including at least one of a phase quantization bitwidth and a phase quantization mode parameter. The method further includes determining, by the wireless device, a phase of channel correlation. The method further includes determining, by the wireless device and based on the phase of channel correlation and the higher layer signaling, a phase indicator indicating a quantized phase of channel correlation. The method further includes sending, by the wireless device, the phase indicator.

A fifth example wireless communication method includes sending, by a network device, a channel state information (CSI) reporting setting associated with one or more CSI resource settings, where each CSI resource setting of the one or more CSI resource settings includes one CSI reference signal (CSI-RS) resource set, and where the one CSI-RS resource set includes one or more CSI-RS resources. The method further includes sending, by the network device, a CSI triggering state list. The method further includes receiving, by the network device, a time-domain channel property (TDCP) report based on the CSI reporting setting and the CSI triggering state list.

A sixth example wireless communication method includes sending, by a network device, a higher layer parameter indicating a quantization bitwidth and sending, by the network device, an amplitude of channel correlation. The method further includes receiving, by the network device, an amplitude indicator indicating a quantized amplitude, where the amplitude indicator is based on the amplitude of channel correlation and the quantization bitwidth.

A seventh example wireless communication method includes sending, by a network device, a higher layer signaling including at least one of a phase quantization bitwidth and a quantization mode adaption parameter. The method further includes sending, by the network device, a phase of channel correlation. The method further includes receiving, by the network device, at least one of a phase indicator indicating a quantized phase of channel correlation and a phase quantization mode parameter, where the phase indicator is based on the phase of channel correlation and the higher layer signaling.

An eighth example wireless communication method includes sending, by a network device, a higher layer signaling including at least one of a phase quantization bitwidth and a phase quantization mode parameter. The method further includes sending, by the network device, a phase of channel correlation. The method further includes receiving, by the network device, a phase indicator indicating a quantized phase of channel correlation, where the phase indicator is based on the phase of channel correlation and the higher layer signaling.

In yet another exemplary embodiment, a device that is configured or operable to perform the above-described methods is disclosed. The device may include a processor configured to implement the above-described methods.

In yet another exemplary embodiment, the above-described methods are embodied in the form of processor-executable code and stored in a non-transitory computer-readable storage medium. The code included in the computer readable storage medium when executed by a processor, causes the processor to implement the methods described in this patent document.

The above and other aspects and their implementations are described in greater detail in the drawings, the descriptions, and the claims.

### BRIEF DESCRIPTION OF THE DRAWINGS

FIG. 1 illustrates an exemplary remote radio head (RRH) arrangement.

FIG. 2 illustrates an exemplary framework of channel station information (CSI) reference signal (CSI-RS) resource configuration.

FIG. 3 is an exemplary flowchart for sending a time-domain channel property (TDCP) report.

FIG. 4 is an exemplary flowchart for sending an amplitude indicator.

FIG. 5 is an exemplary flowchart for sending a phase indicator.

FIG. 6 is another exemplary flowchart for sending a phase indicator.

FIG. 7 is an exemplary flowchart for receiving a TDCP report.

FIG. 8 is an exemplary flowchart for receiving an amplitude indicator.

FIG. 9 is an exemplary flowchart for receiving a phase indicator.

FIG. 10 is another exemplary flowchart for receiving a phase indicator.

FIG. 11 illustrates an exemplary block diagram of a hardware platform that may be a part of a network device or a communication device.

FIG. 12 illustrates exemplary wireless communication including a Base Station (BS) and User Equipment (UE) based on some implementations of the disclosed technology.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. Introduction

In many cases, a Base Station (BS) is expected to provide data transmission services for multiple User Equipments (UEs) with different moving speeds. The different moving speeds will lead to different channel changing speeds between the BS and UEs. To improve serving quality, BS needs to acquire the Time-Domain Channel Property (TDCP), which is a type of Channel State Information (CSI) representing the channel changing speed, and accordingly configure corresponding serving policies for different UEs. Generally, TDCP is measured by UE through Tracking Reference Signals (TRS) and then reported to BS. However, the CSI-RS resource configuration and quantization schemes in TDCP reporting have not been specified.

In this patent document, the following embodiments to address the problem of TDCP report configuration are provided:

CSI-RS resources associated with a TDCP report;

Quantization schemes.

Details of the embodiments are presented below.

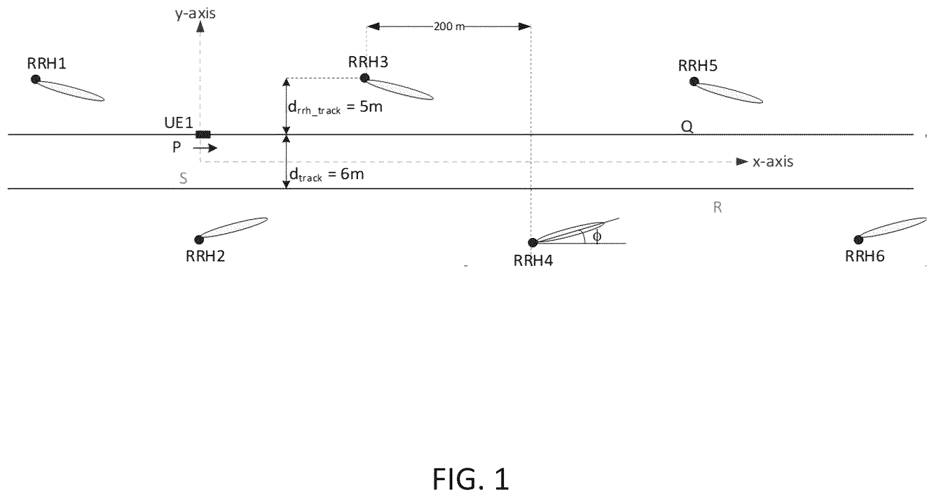

TDCP is one type of CSI representing the changing speed of the channel between UE and BS. TDCP is typically applied in two scenarios: the high-speed railway scenario and the expressway scenario. The high-speed-railway scenario is illustrated in FIG. 1, where there are 6 Remote Radio Heads (RRH). In order to save handover procedure, some of the RRHs correspond to the same cell. That means that there is a long narrow cell along a railway. Similarly, there are several Transmission/Reception Points (TRP) deployed along an expressway.

Generally, a TDCP report includes one or multiple amplitudes and/or phases of channel correlations. The channel correlation c(τ) is measured through a special kind of CSI-RS named TRS, for which two or four CSI-RS resources are configured within two consecutive slots. Detailed specifications of TRS can be found in [clause 5.1.6.1.1 TS 38.214].

Although current specs [TS 38.212 38.214] have specified the report configuration of CSI at length, these specifications are probably unsuitable for TDCP since TDCP differs a lot from other CSIs in terms of report quantities and measurement mechanism.

In this patent document, three embodiments to address the report configuration problem of TDCP are provided, including the aspects of CSI-RS resources associated with TDCP report, CSI-RS emissions used to compute TDCP, and quantization schemes of the report quantities.

First, the explanations of some terminologies to be used in the patent document are provided.

Note that, in this patent document, “UE” is equivalent to wireless communication device.

Note that, in this patent document, “BS” is equivalent to wireless network device, the next Generation Node B (gNB), or TRP.

Note that, in this patent document, “TRS” is equivalent to RS, CSI-RS, Tracking CSI-RS, CSI-RS for Tracking.

Note that, in this patent document, “CSI-RS resource” is equivalent to Non-Zero-Power (NZP) CSI-RS resource, “CSI-RS resource set” is equivalent to NZP CSI-RS resource set.

Note that, in this patent document, “TDCP” is equivalent to CSI, “TDCP report” is equivalent to CSI report.

Note that, in this patent document, “higher layer signaling” or “higher layer parameter” is equivalent to Radio Resource Control (RRC), RRC parameter, Radio Resource Management (RRM), Radio Resource Arrangement (RRA), Downlink Control Information (DCI), or Physical Down-link Control CHannel (PDCCH).

Notes that, in this patent document, “time unit” can be sub-symbol, symbol, slot, sub-frame, frame, or transmission occasion.

Note that, in this patent document, “channel correlation” is equivalent to channel auto-correlation, and channel correlation coefficient.

### II. Embodiment 1: General Description

The measurement and reporting procedure of TDCP generally includes the following steps:

UE receives higher layer signaling.

UE receives DCI triggering a TDCP report.

UE measures TDCP through TRS transmitted from BS.

A TDCP report includes the following quantities:

Y≥1 amplitudes of channel correlations;

Y≥1 phases of channel correlations if the higher layer parameter “PhaseReport” is configured as “on”.

The channel correlation c(i) is measured through TRS by the following formula

$$c ( τ ) = \frac{\vert {\sum }_{n = 0}^{N - 1} {h}_{n} ( t + τ ) \cdot {h}_{n}^{*} ( t ) \vert}{\sqrt{{\sum }_{n} {\vert {h}_{n} ( t + τ ) \vert}^{2}} \sqrt{{\sum }_{n} {\vert {h}_{n} ( t ) \vert}^{2}}}$$

where τ denotes time delay or lag, hₙ(t) denotes the channel response for sub carrier n at time t, and (⋅)* denotes conjugate operation. It is noted that the amplitude of channel correlation has been normalized in the formula.

UE reports TDCP to BS through the Physical Uplink Shared CHannel (PUSCH) indicated by DCI.

### Iii. Embodiment 2: CSI-RS Resources Associated with a TDCP Report

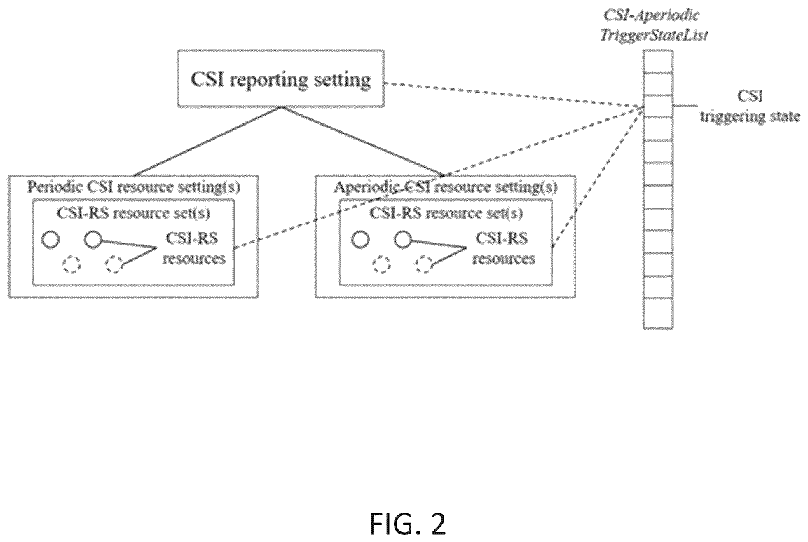

The general CSI-RS resource configuration framework is illustrated in FIG. 2. One CSI report setting is associated with one or multiple periodic and/or aperiodic CSI resource setting(s). Each CSI resource setting includes one or multiple CSI-RS resource set(s), and each CSI-RS resource set includes one or multiple CSI-RS resource(s). An aperiodic CSI report is triggered by the CSI request field in DCI. The CSI request field indicates a CSI triggering state in the higher layer parameter CSI-AperiodicTriggerStateList. The CSI triggering state indicates the CSI report setting and the CSI-RS resource set(s) used to compute the CSI.

For a TDCP report, the CSI-RS resources can be configured by at least one of the following methods:

A CSI reporting setting is associated with an aperiodic CSI resource setting;

The aperiodic CSI resource setting includes a CSI-RS resource set;

For Frequency Range (FR) 1, the CSI-RS resource set includes four CSI-RS resources in two consecutive slots with two CSI-RS resources in each slot;

For FR 2, the CSI-RS resource set includes two CSI-RS resources in one slot, or four CSI-RS resources in two consecutive slots with two CSI-RS resources in each slot;

A triggering state is configured to link the CSI reporting setting and the CSI-RS resource set included in the CSI resource setting;

The CSI-RS resource set included in the CSI resource settings should be configured to be quasi co-located (QCLed) with a (Synchronization Signal and PBCH block) SSB for Doppler shift and average delay (Type C) and spatial Rx parameter (Type D) (if applicable);

UE may assume that all CSI-RS resources associated with the CSI reporting setting are QCLed for Doppler shift, Doppler spread, average delay, and delay spread (Type A) and Type D (if applicable).

Note that, this method is only applicable for the case Y=1.

A CSI reporting setting is associated with two aperiodic CSI resource settings.

Each aperiodic CSI resource setting includes a CSI-RS resource set;

The two CSI-RS resource sets included in the two CSI resource settings should include a same number of CSI-RS resources;

For FR 1, each CSI-RS resource set includes four CSI-RS resources in two consecutive slots with two CSI-RS resources in each slot;

For FR 2, each CSI-RS resource set includes two CSI-RS resources in one slot, or four CSI-RS resources in two consecutive slots with two CSI-RS resources in each slot;

The two CSI-RS resource sets included in two CSI resource settings are configured with different triggering time offsets;

A CSI triggering set is configured to link the CSI reporting setting and the two CSI-RS resource sets included in the two associated CSI resource settings;

The two CSI-RS resource sets included in the two aperiodic CSI resource settings should be configured to be QCLed with a same SSB for Type C and Type D (if applicable);

UE may assume that all CSI-RS resources associated with the CSI reporting setting are QCLed for Type A and Type D (if applicable).

Note that, this method is only applicable for the case Y=1.

A CSI reporting setting is associated with an aperiodic CSI resource setting and a periodic CSI resource setting.

Each of the aperiodic and periodic CSI resource settings includes a CSI-RS resource set;

The CSI-RS resource sets included in the aperiodic and periodic CSI resource settings includes a same number of CSI-RS resources;

For FR 1, each CSI-RS resource set includes four CSI-RS resources in two consecutive slots with two CSI-RS resources in each slot;

For FR 2, each CSI-RS resource set includes two CSI-RS resources in one slot, or four CSI-RS resources in two consecutive slots with two CSI-RS resources in each slot;

The associated aperiodic and periodic CSI-RSs should not be transmitted/received in overlapping slot(s);

A CSI triggering set is configured to link the CSI reporting setting and the CSI-RS resource sets included in the aperiodic and periodic CSI resource settings;

The CSI-RS resource set included in the periodic CSI resource setting is configured to be QCLed with a SSB for Type C and Type D (if applicable);

The CSI-RS resource set included in the aperiodic CSI resource setting is configured to be QCLed with the CSI-RS resource set included in the periodic CSI resource setting for Type A and Type D (if applicable);

UE may assume that all CSI-RS resources associated with the CSI reporting setting are QCLed for Type A and Type D (if applicable).

A CSI reporting setting is associated with a periodic CSI resource setting.

The periodic CSI resource setting includes a CSI-RS resource set;

For FR 1, the CSI-RS resource set includes four CSI-RS resources in two consecutive slots with two CSI-RS resources in each slot;

For FR 2, the CSI-RS resource set includes two CSI-RS resources in one slot, or four CSI-RS resources in two consecutive slots with two CSI-RS resources in each slot;

A triggering state is configured to link the CSI reporting setting and the CSI-RS resource set included in the periodic CSI resource setting;

The CSI-RS resource set included in the CSI resource setting is configured to be QCLed with a SSB for Type C and Type D (if applicable);

UE may assume that all CSI-RS resources associated with the CSI reporting are QCLed for Type A and Type D (if applicable).

Note that, this method is applicable for both the cases Y=1 and Y>1.

A CSI reporting setting is associated with Y+1 periodic CSI resource settings.

Each periodic CSI resource setting includes a CSI-RS resource set;

For FR 1, each CSI-RS resource set includes four CSI-RS resources in two consecutive slots with two CSI-RS resources in each slot;

For FR 2, each CSI-RS resource set includes two CSI-RS resources in one slot, or four CSI-RS resources in two consecutive slots with two CSI-RS resources in each slot;

All CSI-RS resources included in a same CSI-RS resource set are configured with a same periodicity and a same time offset;

CSI-RS resources included in one of the Y+1 CSI-RS resource sets are configured with a periodicity of T, CSI-RS resources included in the other Y of Y+1 CSI-RS resource sets are configured with a periodicity of MT, where M is an integer equal to or greater than 1;

CSI-RS resources included in different CSI-RS resource sets are configured with different triggering time offsets;

The CSI-RS resources included in the different CSI resource sets should not be transmitted/received in overlapping slot(s);

A CSI triggering set is configured to link the CSI reporting setting and the CSI-RS resource sets included in the periodic CSI resource settings;

The CSI-RS resource sets included in the periodic CSI resource settings should be configured to be QCLed with a same SSB for Type C and Type D (if applicable);

UE may assume all CSI-RS resources associated with the CSI reporting setting are QCLed for Type A and Type D (if applicable).

Note that, this method is applicable for both the cases Y=1 and Y>1.

A CSI reporting setting is associated with 2^{k}, k≥1 periodic CSI resource settings, where k is a parameter greater than or equal to 1.

Each periodic CSI resource setting includes a CSI-RS resource set;

For FR 1, each CSI-RS resource set includes four CSI-RS resources in two consecutive slots with two CSI-RS resources in each slot;

For FR 2, each CSI-RS resource set includes two CSI-RS resources in one slot, or four CSI-RS resources in two consecutive slots with two CSI-RS resources in each slot;

All CSI-RS resources included in a same CSI-RS resource set are configured with a same periodicity and a same time offset;

CSI-RS resources included in the 2^{k} different CSI-RS resource sets are configured with a same periodicity P;

CSI-RS resources included in the 2^{k} different CSI-RS resource sets are configured with time offsets X,

$$X + \frac{P}{{2}^{k}} , X + \frac{2 P}{{2}^{k}} , … , X + \frac{( {2}^{k} - 1 ) P}{{2}^{k}} ,$$

respectively, where X is a constant value;

A CSI triggering set is configured to link the CSI report setting and the 2^{k} CSI-RS resource sets included in the 2^{k} periodic CSI-RS resource settings;

The 2^{k} CSI-RS resource sets included in the 2^{k} periodic CSI-RS resource settings should be configured to be QCLed with a same SSB for Type C and Type D (if applicable);

UE may assume all CSI-RS resources associated with the CSI reporting setting are QCLed for Type A and Type D (if applicable).

Note that, this method is applicable for both the cases Y=1 and Y>1.

### Iv. Embodiment 3: Quantization Scheme of the Amplitudes and Phases in a TDCP Report

UE quantizes the amplitudes of channel correlations according to at least one of the following rules:

The quantization range is from 0 to 1;

The quantization bitwidth is 3, 4, or 5;

The quantization bitwidth is a configurable higher layer parameter “AmplitudeQuantizationBitwidth”;

The quantization granularity increases as the amplitude decreases;

The quantization granularity increases exponentially or linearly as the amplitude decreases;

If the bitwidth of quantization is 3, the mapping between the amplitude indicator k and the amplitude of channel correlation |c| is given by one of the following tables:

| k | \|c\| |
|---|---|
| 0 | 1 − ½¹ |
| 1 | 1 − ½² |
| 2 | 1 − ½³ |
| 3 | 1 − ½⁴ |
| 4 | 1 − ½⁵ |
| 5 | 1 − ½⁶ |
| 6 | 1 − ½⁷ |
| 7 | 1 − ½⁸ |

| k | \|c\| |
|---|---|
| 0 | 1 − \sqrt{½}¹ |
| 1 | 1 − \sqrt{½}² |
| 2 | 1 − \sqrt{½}³ |
| 3 | 1 − \sqrt{½}⁴ |
| 4 | 1 − \sqrt{½}⁵ |
| 5 | 1 − \sqrt{½}⁶ |
| 6 | 1 − \sqrt{½}⁷ |
| 7 | 1 − \sqrt{½}⁸ |

| k | \|c\| |
|---|---|
| 0 | 2(⅛) − (⅛)² |
| 1 | 2( 2/8) − ( 2/8)² |
| 2 | 2(⅜) − (⅜)² |
| 3 | 2( 4/8) − ( 4/8)² |
| 4 | 2(⅝) − (⅝)² |
| 5 | 2( 6/8) − ( 6/8)² |
| 6 | 2(⅞) − (⅞)² |
| 7 | 1 |

If the bitwidth of quantization is 4, the mapping between the amplitude indicator k and the amplitude of channel correlation |c| is given by one of the following tables:

| k | \|c\| |
|---|---|
| 0 | 1 − \sqrt{½}¹ |
| 1 | 1 − \sqrt{½}² |
| 2 | 1 − \sqrt{½}³ |
| 3 | 1 − \sqrt{½}⁴ |
| 4 | 1 − \sqrt{½}⁵ |
| 5 | 1 − \sqrt{½}⁶ |
| 6 | 1 − \sqrt{½}⁷ |
| 7 | 1 − \sqrt{½}⁸ |
| 8 | 1 − \sqrt{½}⁹ |
| 9 | 1 − \sqrt{½}¹⁰ |
| 10 | 1 − \sqrt{½}¹¹ |
| 11 | 1 − \sqrt{½}¹² |
| 12 | 1 − \sqrt{½}¹³ |
| 13 | 1 − \sqrt{½}¹⁴ |
| 14 | 1 − \sqrt{½}¹⁵ |
| 15 | 1 |

| k | \|c\| | k | \|c\| |
|---|---|---|---|
| 0 | $1 - \sqrt[4]{1 / {2}^{1}}$ | 8 | $1 - \sqrt[4]{1 / {2}^{9}}$ |
| 1 | $1 - \sqrt[4]{1 / {2}^{2}}$ | 9 | $1 - \sqrt[4]{1 / {2}^{10}}$ |
| 2 | $1 - \sqrt[4]{1 / {2}^{3}}$ | 10 | $1 - \sqrt[4]{1 / {2}^{11}}$ |
| 3 | $1 - \sqrt[4]{1 / {2}^{4}}$ | 11 | $1 - \sqrt[4]{1 / {2}^{12}}$ |
| 4 | $1 - \sqrt[4]{1 / {2}^{5}}$ | 12 | $1 - \sqrt[4]{1 / {2}^{13}}$ |
| 5 | $1 - \sqrt[4]{1 / {2}^{6}}$ | 13 | $1 - \sqrt[4]{1 / {2}^{14}}$ |
| 6 | $1 - \sqrt[4]{1 / {2}^{7}}$ | 14 | $1 - \sqrt[4]{1 / {2}^{15}}$ |
| 7 | $1 - \sqrt[4]{1 / {2}^{8}}$ | 15 | 1 |

| k | \|c\| |
|---|---|
| 0 | 2( 1/16) − ( 1/16)² |
| 1 | 2( 2/16) − ( 2/16)² |
| 2 | 2( 3/16) − ( 3/16)² |
| 3 | 2( 4/16) − ( 4/16)² |
| 4 | 2( 5/16) − ( 5/16)² |
| 5 | 2( 6/16) − ( 6/16)² |
| 6 | 2( 7/16) − ( 7/16)² |
| 7 | 2( 8/16) − ( 8/16)² |
| 8 | 2( 9/16) − ( 9/16)² |
| 9 | 2( 10/16) − ( 10/16)² |
| 10 | 2( 11/16) − ( 11/16)² |
| 11 | 2( 12/16) − ( 12/16)² |
| 12 | 2( 13/16) − ( 13/16)² |
| 13 | 2( 14/16) − ( 14/16)² |
| 14 | 2( 15/16) − ( 15/16)² |
| 15 | 1 |

If the bitwidth of quantization is 5, the mapping between the amplitude indicator k and the amplitude of channel correlation |c| is given by one of the following tables:

| k | \|c\| |
|---|---|
| 0 | $1 - \sqrt[4]{1 / {2}^{1}}$ |
| 1 | $1 - \sqrt[4]{1 / {2}^{2}}$ |
| 2 | $1 - \sqrt[4]{1 / {2}^{3}}$ |
| 3 | $1 - \sqrt[4]{1 / {2}^{4}}$ |
| 4 | $1 - \sqrt[4]{1 / {2}^{5}}$ |
| 5 | $1 - \sqrt[4]{1 / {2}^{6}}$ |
| 6 | $1 - \sqrt[4]{1 / {2}^{7}}$ |
| 7 | $1 - \sqrt[4]{1 / {2}^{8}}$ |
| 8 | $1 - \sqrt[4]{1 / {2}^{9}}$ |
| 9 | $1 - \sqrt[4]{1 / {2}^{10}}$ |
| 10 | $1 - \sqrt[4]{1 / {2}^{11}}$ |
| 11 | $1 - \sqrt[4]{1 / {2}^{12}}$ |
| 12 | $1 - \sqrt[4]{1 / {2}^{13}}$ |
| 13 | $1 - \sqrt[4]{1 / {2}^{14}}$ |
| 14 | $1 - \sqrt[4]{1 / {2}^{15}}$ |
| 15 | $1 - \sqrt[4]{1 / {2}^{16}}$ |
| 16 | $1 - \sqrt[4]{1 / {2}^{17}}$ |
| 17 | $1 - \sqrt[4]{1 / {2}^{18}}$ |
| 18 | $1 - \sqrt[4]{1 / {2}^{19}}$ |
| 19 | $1 - \sqrt[4]{1 / {2}^{20}}$ |
| 20 | $1 - \sqrt[4]{1 / {2}^{21}}$ |
| 21 | $1 - \sqrt[4]{1 / {2}^{22}}$ |
| 22 | $1 - \sqrt[4]{1 / {2}^{23}}$ |
| 23 | $1 - \sqrt[4]{1 / {2}^{24}}$ |
| 24 | $1 - \sqrt[4]{1 / {2}^{25}}$ |
| 25 | $1 - \sqrt[4]{1 / {2}^{26}}$ |
| 26 | $1 - \sqrt[4]{1 / {2}^{27}}$ |
| 27 | $1 - \sqrt[4]{1 / {2}^{28}}$ |
| 28 | $1 - \sqrt[4]{1 / {2}^{29}}$ |
| 29 | $1 - \sqrt[4]{1 / {2}^{30}}$ |
| 30 | $1 - \sqrt[4]{1 / {2}^{31}}$ |
| 31 | 1 |

| k | \|c\| |
|---|---|
| 0 | $1 - \sqrt[8]{1 / {2}^{1}}$ |
| 1 | $1 - \sqrt[8]{1 / {2}^{2}}$ |
| 2 | $1 - \sqrt[8]{1 / {2}^{3}}$ |
| 3 | $1 - \sqrt[8]{1 / {2}^{4}}$ |
| 4 | $1 - \sqrt[8]{1 / {2}^{5}}$ |
| 5 | $1 - \sqrt[8]{1 / {2}^{6}}$ |
| 6 | $1 - \sqrt[8]{1 / {2}^{7}}$ |
| 7 | $1 - \sqrt[8]{1 / {2}^{8}}$ |
| 8 | $1 - \sqrt[8]{1 / {2}^{9}}$ |
| 9 | $1 - \sqrt[8]{1 / {2}^{10}}$ |
| 10 | $1 - \sqrt[8]{1 / {2}^{11}}$ |
| 11 | $1 - \sqrt[8]{1 / {2}^{12}}$ |
| 12 | $1 - \sqrt[8]{1 / {2}^{13}}$ |
| 13 | $1 - \sqrt[8]{1 / {2}^{14}}$ |
| 14 | $1 - \sqrt[8]{1 / {2}^{15}}$ |
| 15 | $1 - \sqrt[8]{1 / {2}^{16}}$ |
| 16 | $1 - \sqrt[8]{1 / {2}^{17}}$ |
| 17 | $1 - \sqrt[8]{1 / {2}^{18}}$ |
| 18 | $1 - \sqrt[8]{1 / {2}^{19}}$ |
| 19 | $1 - \sqrt[8]{1 / {2}^{20}}$ |
| 20 | $1 - \sqrt[8]{1 / {2}^{21}}$ |
| 21 | $1 - \sqrt[8]{1 / {2}^{22}}$ |
| 22 | $1 - \sqrt[8]{1 / {2}^{23}}$ |
| 23 | $1 - \sqrt[8]{1 / {2}^{24}}$ |
| 24 | $1 - \sqrt[8]{1 / {2}^{25}}$ |
| 25 | $1 - \sqrt[8]{1 / {2}^{26}}$ |
| 26 | $1 - \sqrt[8]{1 / {2}^{27}}$ |
| 27 | $1 - \sqrt[8]{1 / {2}^{28}}$ |
| 28 | $1 - \sqrt[8]{1 / {2}^{29}}$ |
| 29 | $1 - \sqrt[8]{1 / {2}^{30}}$ |
| 30 | $1 - \sqrt[8]{1 / {2}^{31}}$ |
| 31 | 1 |

| k | \| c \| |
|---|---|
| 0 | 2( 1/32) − ( 1/32)² |
| 1 | 2( 2/32) − ( 2/32)² |
| 2 | 2( 3/32) − ( 3/32)² |
| 3 | 2( 4/32) − ( 4/32)² |
| 4 | 2( 5/32) − ( 5/32)² |
| 5 | 2( 6/32) − ( 6/32)² |
| 6 | 2( 7/32) − ( 7/32)² |
| 7 | 2( 8/32) − ( 8/32)² |
| 8 | 2( 9/32) − ( 9/32)² |
| 9 | 2( 10/32) − ( 10/32)² |
| 10 | 2( 11/32) − ( 11/32)² |
| 11 | 2( 12/32) − ( 12/32)² |
| 12 | 2( 13/32) − ( 13/32)² |
| 13 | 2( 14/32) − ( 14/32)² |
| 14 | 2( 15/32) − ( 15/32)² |
| 15 | 2( 16/32) − ( 16/32)² |
| 16 | 2( 17/32) − ( 17/32)² |
| 17 | 2( 18/32) − ( 18/32)² |
| 18 | 2( 19/32) − ( 19/32)² |
| 19 | 2( 20/32) − ( 20/32)² |
| 20 | 2( 21/32) − ( 21/32)² |
| 21 | 2( 22/32) − ( 22/32)² |
| 22 | 2( 23/32) − ( 23/32)² |
| 23 | 2( 24/32) − ( 24/32)² |
| 24 | 2( 25/32) − ( 25/32)² |
| 25 | 2( 26/32) − ( 26/32)² |
| 26 | 2( 27/32) − ( 27/32)² |
| 27 | 2( 28/32) − ( 28/32)² |
| 28 | 2( 29/32) − ( 29/32)² |
| 29 | 2( 30/32) − ( 30/32)² |
| 30 | 2( 31/32) − ( 31/32)² |
| 31 | 1 |

UE quantizes the phases of channel correlations according to one of the following methods:

UE quantizes the phases of channel correlation according to a higher layer parameter “PhaseQuantizationBitwidth” indicating the quantization bitwidth, which can be configured as 3 or 4;

The mapping between the phase indicator 1 and the phase of channel correlation ang(c) is determined by the parameter “PhaseQuantizationMode”, whose candidate values are 0 and 1;

UE determines the parameter “PhaseQuantizationMode” and reports it to BS;

If the quantization bitwidth is configured as 3, the mapping between the phase indicator l and the phase of channel correlation ang(c) can be given by one of the following tables:

| | ang(c) | ang(c) |
|---|---|---|
| l | PhaseQuantizatonMode = 0 | PhaseQuantizationMode = 1 |
| 0 | 0 | (1 − ½¹) · 2π |
| 1 | ½⁷ · 2π | (1 − ½²) · 2π |
| 2 | ½⁶ · 2π | (1 − ½³) · 2π |
| 3 | ½⁵ · 2π | (1 − ½⁴) · 2π |
| 4 | ½⁴ · 2π | (1 − ½⁵) · 2π |
| 5 | ½³ · 2π | (1 − ½⁶) · 2π |
| 6 | ½² · 2π | (1 − ½⁷) · 2π |
| 7 | ½¹ · 2π | 2π |

| | ang(c) | ang(c) |
|---|---|---|
| l | PhaseQuantizatonMode = 0 | PhaseQuantizationMode = 1 |
| 0 | 0 | π |
| 1 | 1/7 π | (1 + 1/7)π |
| 2 | 2/7 π | (1 + 2/7)π |
| 3 | 3/7 π | (1 + 3/7)π |
| 4 | 4/7 π | (1 + 4/7)π |
| 5 | 5/7 π | (1 + 5/7)π |
| 6 | 6/7 π | (1 + 6/7)π |
| 7 | π | 2π |

If the quantization bitwidth is configured as 4, the mapping between the phase indicator 1 and the phase of channel correlation ang(c) can be given by one of the following tables:

| | ang(c) | ang(c) |
|---|---|---|
| l | PhaseQuantizatonMode = 0 | PhaseQuantizationMode = 1 |
| 0 | 0 | (1 − 1/\sqrt{2¹}) · 2π |
| 1 | 1/\sqrt{2¹⁵} · 2π | (1 − 1/\sqrt{2²}) · 2π |
| 2 | 1/\sqrt{2¹⁴} · 2π | (1 − 1/\sqrt{2³}) · 2π |
| 3 | 1/\sqrt{2¹³} · 2π | (1 − 1/\sqrt{2⁴}) · 2π |
| 4 | 1/\sqrt{2¹²} · 2π | (1 − 1/\sqrt{2⁵}) · 2π |
| 5 | 1/\sqrt{2¹¹} · 2π | (1 − 1/\sqrt{2⁶}) · 2π |
| 6 | 1/\sqrt{2¹⁰} · 2π | (1 − 1/\sqrt{2⁷}) · 2π |
| 7 | 1/\sqrt{2⁹} · 2π | (1 − 1/\sqrt{2⁸}) · 2π |
| 8 | 1/\sqrt{2⁸} · 2π | (1 − 1/\sqrt{2⁹}) · 2π |
| 9 | 1/\sqrt{2⁷} · 2π | (1 − 1/\sqrt{2¹⁰}) · 2π |
| 10 | 1/\sqrt{2⁶} · 2π | (1 − 1/\sqrt{2¹¹}) · 2π |
| 11 | 1/\sqrt{2⁵} · 2π | (1 − 1/\sqrt{2¹²}) · 2π |
| 12 | 1/\sqrt{2⁴} · 2π | (1 − 1/\sqrt{2¹³}) · 2π |
| 13 | 1/\sqrt{2³} · 2π | (1 − 1/\sqrt{2¹⁴}) · 2π |
| 14 | 1/\sqrt{2²} · 2π | (1 − 1/\sqrt{2¹⁵}) · 2π |
| 15 | 1/\sqrt{2¹} · 2π | 2π |

| | ang(c) | ang(c) |
|---|---|---|
| l | PhaseQuantizatonMode = 0 | PhaseQuantizationMode = 1 |
| 0 | 0 | π |
| 1 | 1/15 π | ( 1/15 + 1)π |
| 2 | 2/15 π | ( 2/15 + 1)π |
| 3 | 3/15 π | ( 3/15 + 1)π |
| 4 | 4/15 π | ( 4/15 + 1)π |
| 5 | 5/15 π | ( 5/15 + 1)π |
| 6 | 6/15 π | ( 6/15 + 1)π |
| 7 | 7/15 π | ( 7/15 + 1)π |
| 8 | 8/15 π | ( 8/15 + 1)π |
| 9 | 9/15 π | ( 9/15 + 1)π |
| 10 | 10/15 π | ( 10/15 + 1)π |
| 11 | 11/15 π | ( 11/15 + 1)π |
| 12 | 12/15 π | ( 12/15 + 1)π |
| 13 | 13/15 π | ( 13/15 + 1)π |
| 14 | 14/15 π | ( 14/15 + 1)π |
| 15 | π | 2π |

UE quantizes the phases of channel correlation according to a higher layer parameter “PhaseQuantizationBitwidth” indicating the quantization bitwidth, which can be configured as 3 or 4, and a higher layer parameter “QuantizationModeAdaption”, which can be configured as “on” or “off”;

If the higher layer parameter “QuantizationModeAdaption” is configured as “off”, the mapping between the phase indicator l and the phase of channel correlation is determined by the higher layer parameter “PhaseQuantizationBitwidth”;

If the higher layer parameter “PhaseQuantizationBitwidth” is configured as 3, the mapping between the phase indicator l and the phase of channel correlation ang(c) can be given by the following table:

| l | ang(c) |
|---|---|
| 0 | 0 |
| 1 | π/4 |
| 2 | 2π/4 |
| 3 | 3π/4 |
| 4 | 4π/4 |
| 5 | 5π/4 |
| 6 | 6π/4 |
| 7 | 7π/4 |

If the higher layer parameter “PhaseQuantizationBitwidth” is configured as 4, the mapping between the phase indicator l and the phase of channel correlation ang(c) can be given by the following table:

| l | ang(c) |
|---|---|
| 0 | 0 |
| 1 | π/8 |
| 2 | 2π/8 |
| 3 | 3π/8 |
| 4 | 4π/8 |
| 5 | 5π/8 |
| 6 | 6π/8 |
| 7 | 7π/8 |
| 8 | 8π/8 |
| 9 | 9π/8 |
| 10 | 10π/8 |
| 11 | 11π/8 |
| 12 | 12π/8 |
| 13 | 13π/8 |
| 14 | 14π/8 |
| 15 | 15π/8 |

If the higher layer parameter “QuantizationModeAdaption” is configured as “on”, the mapping between the phase indicator l and the phase of channel correlation is determined by the higher layer parameter “PhaseQuantizationBitwidth” and a parameter “PhaseQuantizationMode” whose candidate values are 0 and 1;

UE determines the parameter “PhaseQuantizationMode” and reports it to BS;

If the quantization bitwidth is configured as 3, the mapping between the phase indicator l and the phase of channel correlation ang(c) can be given by one of the following tables:

| | ang(c) | ang(c) |
|---|---|---|
| l | PhaseQuantizatonMode = 0 | PhaseQuantizationMode = 1 |
| 0 | 0 | (1 − ½¹) · 2π |
| 1 | ½⁷ · 2π | (1 − ½²) · 2π |
| 2 | ½⁶ · 2π | (1 − ½³) · 2π |
| 3 | 1/2⁵ · 2π | (1 − ½⁴) · 2π |
| 4 | ½⁴ · 2π | (1 − ½⁵) · 2π |
| 5 | ½³ · 2π | (1 − ½⁶) · 2π |
| 6 | ½² · 2π | (1 − ½⁷) · 2π |
| 7 | ½¹ · 2π | 2π |

| | ang(c) | ang(c) |
|---|---|---|
| l | PhaseQuantizatonMode = 0 | PhaseQuantizationMode = 1 |
| 0 | 0 | π |
| 1 | 1/7 π | (1 + 1/7)π |
| 2 | 2/7 π | (1 + 2/7)π |
| 3 | 3/7 π | (1 + 3/7)π |
| 4 | 4/7 π | (1 + 4/7)π |
| 5 | 5/7 π | (1 + 5/7)π |
| 6 | 6/7 π | (1 + 6/7)π |
| 7 | π | 2π |

If the quantization bitwidth is configured as 4, the mapping between the phase indicator l and the phase of channel correlation ang(c) can be given by one of the following tables:

| | ang(c) | ang(c) |
|---|---|---|
| l | PhaseQuantizatonMode = 0 | PhaseQuantizationMode = 1 |
| 0 | 0 | (1 − 1/\sqrt{2¹}) · 2π |
| 1 | 1/\sqrt{2¹⁵} · 2π | (1 − 1/\sqrt{2²}) · 2π |
| 2 | 1/\sqrt{2¹⁴} · 2π | (1 − 1/\sqrt{2³}) · 2π |
| 3 | 1/\sqrt{2¹³} · 2π | (1 − 1/\sqrt{2⁴}) · 2π |
| 4 | 1/\sqrt{2¹²} · 2π | (1 − 1/\sqrt{2⁵}) · 2π |
| 5 | 1/\sqrt{2¹¹} · 2π | (1 − 1/\sqrt{2⁶}) · 2π |
| 6 | 1/\sqrt{2¹⁰} · 2π | (1 − 1/\sqrt{2⁷}) · 2π |
| 7 | 1/\sqrt{2⁹} · 2π | (1 − 1/\sqrt{2⁸}) · 2π |
| 8 | 1/\sqrt{2⁸} · 2π | (1 − 1/\sqrt{2⁹}) · 2π |
| 9 | 1/\sqrt{2⁷} · 2π | (1 − 1/\sqrt{2¹⁰}) · 2π |
| 10 | 1/\sqrt{2⁶} · 2π | (1 − 1/\sqrt{2¹¹}) · 2π |
| 11 | 1/\sqrt{2⁵} · 2π | (1 − 1/\sqrt{2¹²}) · 2π |
| 12 | 1/\sqrt{2⁴} · 2π | (1 − 1/\sqrt{2¹³}) · 2π |
| 13 | 1/\sqrt{2³} · 2π | (1 − 1/\sqrt{2¹⁴}) · 2π |
| 14 | 1/\sqrt{2²} · 2π | (1 − 1/\sqrt{2¹⁵}) · 2π |
| 15 | 1/\sqrt{2¹} · 2π | 2π |

| | ang(c) | ang(c) |
|---|---|---|
| l | PhaseQuantizatonMode = 0 | PhaseQuantizationMode = 1 |
| 0 | 0 | π |
| 1 | 1/15 π | ( 1/15 + 1)π |
| 2 | 2/15 π | ( 2/15 + 1)π |
| 3 | 3/15 π | ( 3/15 + 1)π |
| 4 | 4/15 π | ( 4/15 + 1)π |
| 5 | 5/15 π | ( 5/15 + 1)π |
| 6 | 6/15 π | ( 6/15 + 1)π |
| 7 | 7/15 π | ( 7/15 + 1)π |
| 8 | 8/15 π | ( 8/15 + 1)π |
| 9 | 9/15 π | ( 9/15 + 1)π |
| 10 | 10/15 π | ( 10/15 + 1)π |
| 11 | 11/15 π | ( 11/15 + 1)π |
| 12 | 12/15 π | ( 12/15 + 1)π |
| 13 | 13/15 π | ( 13/15 + 1)π |
| 14 | 14/15 π | ( 14/15 + 1)π |
| 15 | π | 2π |

UE quantizes the phases of channel correlation according to a higher layer parameter “PhaseQuantizationBitwidth” indicating the quantization bitwidth, which can be configured as 3 or 4, and a higher layer parameter “PhaseQuantizationMode”, which can be configured as 0 or 1;

The mapping between the phase indicator l and the phase of channel correlation is determined by the higher layer parameters “PhaseQuantizationBitwidth” and “PhaseQuantizationMode”;

If the quantization bitwidth is configured as 3, the mapping between the phase indicator l and the phase of channel correlation ang(c) can be given by one of the following tables:

| | ang(c) | ang(c) |
|---|---|---|
| l | PhaseQuantizatonMode = 0 | PhaseQuantizationMode = 1 |
| 0 | 0 | (1 − ½¹) · 2π |
| 1 | ½⁷ · 2π | (1 − ½²) · 2π |
| 2 | ½⁶ · 2π | (1 − ½³) · 2π |
| 3 | ½⁵ · 2π | (1 − ½⁴) · 2π |
| 4 | ½⁴ · 2π | (1 − ½⁵) · 2π |
| 5 | ½³ · 2π | (1 − ½⁶) · 2π |
| 6 | ½² · 2π | (1 − ½⁷) · 2π |
| 7 | ½¹ · 2π | 2π |

| | ang(c) | ang(c) |
|---|---|---|
| l | PhaseQuantizatonMode = 0 | PhaseQuantizationMode = 1 |
| 0 | 0 | π |
| 1 | 1/7 π | (1 + 1/7)π |
| 2 | 2/7 π | (1 + 2/7)π |
| 3 | 3/7 π | (1 + 3/7)π |
| 4 | 4/7 π | (1 + 4/7)π |
| 5 | 5/7 π | (1 + 5/7)π |
| 6 | 6/7 π | (1 + 6/7)π |
| 7 | π | 2π |

If the quantization bitwidth is configured as 4, the mapping between the phase indicator l and the phase of channel correlation ang(c) can be given by one of the following tables:

| | ang(c) | ang(c) |
|---|---|---|
| l | PhaseQuantizatonMode = 0 | PhaseQuantizationMode = 1 |
| 0 | 0 | (1 − 1/\sqrt{2¹}) · 2π |
| 1 | 1/\sqrt{2¹⁵} · 2π | (1 − 1/\sqrt{2²}) · 2π |
| 2 | 1/\sqrt{2¹⁴} · 2π | (1 − 1/\sqrt{2³}) · 2π |
| 3 | 1/\sqrt{2¹³} · 2π | (1 − 1/\sqrt{2⁴}) · 2π |
| 4 | 1/\sqrt{2¹²} · 2π | (1 − 1/\sqrt{2⁵}) · 2π |
| 5 | 1/\sqrt{2¹¹} · 2π | (1 − 1/\sqrt{2⁶}) · 2π |
| 6 | 1/\sqrt{2¹⁰} · 2π | (1 − 1/\sqrt{2⁷}) · 2π |
| 7 | 1/\sqrt{2⁹} · 2π | (1 − 1/\sqrt{2⁸}) · 2π |
| 8 | 1/\sqrt{2⁸} · 2π | (1 − 1/\sqrt{2⁹}) · 2π |
| 9 | 1/\sqrt{2⁷} · 2π | (1 − 1/\sqrt{2¹⁰}) · 2π |
| 10 | 1/\sqrt{2⁶} · 2π | (1 − 1/\sqrt{2¹¹}) · 2π |
| 11 | 1/\sqrt{2⁵} · 2π | (1 − 1/\sqrt{2¹²}) · 2π |
| 12 | 1/\sqrt{2⁴} · 2π | (1 − 1/\sqrt{2¹³}) · 2π |
| 13 | 1/\sqrt{2³} · 2π | (1 − 1/\sqrt{2¹⁴}) · 2π |
| 14 | 1/\sqrt{2²} · 2π | (1 − 1/\sqrt{2¹⁵}) · 2π |
| 15 | 1/\sqrt{2¹} · 2π | 2π |

| | ang(c) | ang(c) |
|---|---|---|
| l | PhaseQuantizatonMode = 0 | PhaseQuantizationMode = 1 |
| 0 | 0 | π |
| 1 | 1/15 π | ( 1/15 + 1)π |
| 2 | 2/15 π | ( 2/15 + 1)π |
| 3 | 3/15 π | ( 3/15 + 1)π |
| 4 | 4/15 π | ( 4/15 + 1)π |
| 5 | 5/15 π | ( 5/15 + 1)π |
| 6 | 6/15 π | ( 6/15 + 1)π |
| 7 | 7/15 π | ( 7/15 + 1)π |
| 8 | 8/15 π | ( 8/15 + 1)π |
| 9 | 9/15 π | ( 9/15 + 1)π |
| 10 | 10/15 π | ( 10/15 + 1)π |
| 11 | 11/15 π | ( 11/15 + 1)π |
| 12 | 12/15 π | ( 12/15 + 1)π |
| 13 | 13/15 π | ( 13/15 + 1)π |
| 14 | 14/15 π | ( 14/15 + 1)π |
| 15 | π | 2π |

The quantization range of phase is determined by the amplitude of channel correlation.

This patent document provides a method to address the measurement and reporting problem of TDCP:

CSI-RS resources associated with a TDCP report;

Quantization schemes,
where one embodiment provides a flexible way to configure the CSI-RS resources used to measure TDCP, and one embodiment provides a highly efficient way to quantize the amplitudes and phases of channel correlations in a TDCP report.

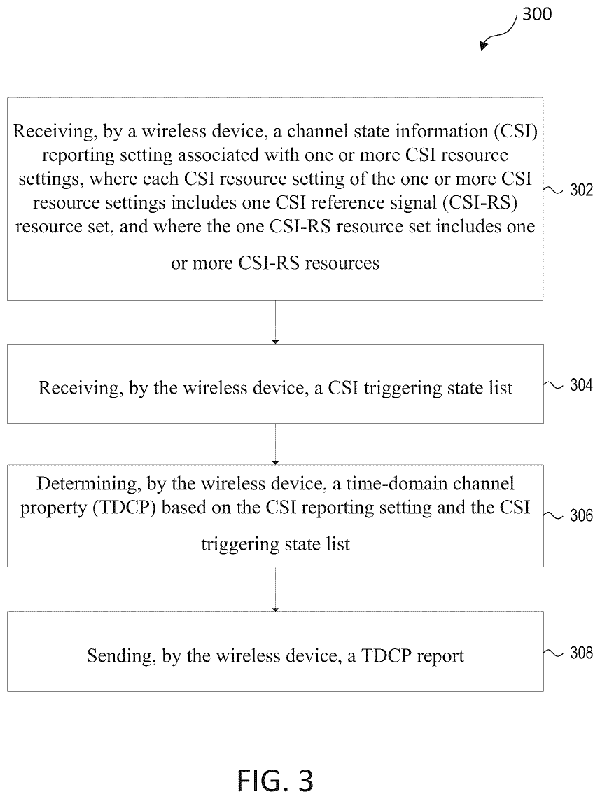

FIG. 3 is an exemplary flowchart for sending a TDCP report. Operation 302 includes receiving, by a wireless device, a channel state information (CSI) reporting setting associated with one or more CSI resource settings, where each CSI resource setting of the one or more CSI resource settings includes one CSI reference signal (CSI-RS) resource set, and where the one CSI-RS resource set includes one or more CSI-RS resources. Operation 304 includes receiving, by the wireless device, a CSI triggering state list. Operation 306 includes determining, by the wireless device, a time-domain channel property (TDCP) based on the CSI reporting setting and the CSI triggering state list. Operation 308 includes sending, by the wireless device, a TDCP report. In some embodiments, the method can be implemented according to Embodiments 1-3. In some embodiments, performing further steps of the method can be based on a better system performance than a legacy protocol.

In some embodiments, the CSI reporting setting is associated with an aperiodic CSI resource setting, where the aperiodic CSI resource setting includes a CSI-RS resource set. In some embodiments, the CSI triggering state list includes a triggering state configured to link the CSI reporting setting and the CSI-RS resource set. In some embodiments, the CSI-RS resource set is configured to be quasi co-located (QCLed) with a synchronization signal block (SSB) for at least one of the following: Doppler shift, average delay, and spatial Rx parameter. In some embodiments, all CSI-RS resources associated with the CSI reporting setting are quasi co-located (QCLed) for at least one of the following: Doppler shift, Doppler spread, average delay, delay spread, and spatial Rx parameter.

In some embodiments, the CSI reporting setting is associated with two aperiodic CSI resource settings, where the two aperiodic CSI resource settings include two CSI-RS resource sets with each aperiodic CSI resource setting including one CSI-RS resource set. In some embodiments, the two CSI-RS resource sets include a same number of CSI-RS resources. In some embodiments, the two CSI-RS resource sets are configured with different triggering time offsets. In some embodiments, the CSI triggering state list includes a triggering set configured to link the CSI reporting setting and the two CSI-RS resource sets. In some embodiments, the two CSI-RS resource sets are configured to be quasi co-located (QCLed) with a same synchronization signal block (SSB) for at least one of the following: Doppler shift, average delay, and spatial Rx parameter. In some embodiments, all CSI-RS resources associated with the CSI reporting setting are quasi co-located (QCLed) for at least one of the following: Doppler shift, Doppler spread, average delay, delay spread, and spatial Rx parameter.

In some embodiments, the CSI reporting setting is associated with an aperiodic CSI resource setting and a periodic CSI resource setting, where the aperiodic CSI resource setting includes a first CSI-RS resource set, and where the periodic CSI resource setting includes a second CSI-RS resource set. In some embodiments, the first and second CSI-RS resource sets include a same number of CSI-RS resources. In some embodiments, CSI-RSs associated with the aperiodic CSI resource setting and CSI-RSs associated with the periodic CSI resource setting are not to be transmitted or received in overlapping slots. In some embodiments, the CSI triggering state list includes a triggering set configured to link the CSI reporting setting and the first and second CSI-RS resource sets. In some embodiments, the second CSI-RS resource set is configured to be quasi co-located (QCLed) with a synchronization signal block (SSB) for at least one of the following: Doppler shift, average delay, and spatial Rx parameter. In some embodiments, the first CSI-RS resource set is configured to be quasi co-located (QCLed) with the second CSI-RS resource set for at least one of the following: Doppler shift, Doppler spread, average delay, delay spread, and spatial Rx parameter. In some embodiments, all CSI-RS resources associated with the CSI reporting setting are quasi co-located (QCLed) for at least one of the following: Doppler shift, Doppler spread, average delay, delay spread, and spatial Rx parameter.

In some embodiments, the CSI reporting setting is associated with a periodic CSI resource setting, where the periodic CSI resource setting includes a CSI-RS resource set. In some embodiments, the CSI triggering state list includes a triggering state configured to link the CSI reporting setting and the CSI-RS resource set. In some embodiments, the CSI-RS resource set is configured to be quasi co-located (QCLed) with a synchronization signal block (SSB) for at least one of the following: Doppler shift, average delay, and spatial Rx parameter. In some embodiments, all CSI-RS resources associated with the CSI reporting setting are quasi co-located (QCLed) for at least one of the following: Doppler shift, Doppler spread, average delay, delay spread, and spatial Rx parameter.

In some embodiments, the CSI reporting setting is associated with a first periodic CSI resource setting and a second periodic CSI resource setting, where the first periodic CSI resource setting includes a first CSI-RS resource set, and where the second periodic CSI resource setting includes a second CSI-RS resource set. In some embodiments, CSI-RS resources included in the first CSI-RS resource set are configured with a first periodicity, and CSI-RS resources included in the second CSI-RS resource set are configured with a second periodicity, where the first and second periodicities have a mapping relationship. In some embodiments, CSI-RS resources included in the first CSI-RS resource set are configured with a first periodicity, and CSI-RS resources included in the second CSI-RS resource set are configured with a second periodicity, where the second periodicity is obtained by multiplying the first periodicity by an integer equal to or greater than 1. In some embodiments, CSI-RS resources included in the first and second CSI-RS resource sets are configured with different triggering time offsets. In some embodiments, CSI-RS resources included in the first and second CSI-RS resource sets are not to be transmitted or received in overlapping slots. In some embodiments, the CSI triggering state list includes a triggering set configured to link the CSI reporting setting and the first and second CSI-RS resource sets. In some embodiments, the first and second CSI-RS resource sets are configured to be quasi co-located (QCLed) with a same synchronization signal block (SSB) for at least one of the following: Doppler shift, average delay, and spatial Rx parameter. In some embodiments, all CSI-RS resources associated with the CSI reporting setting are quasi co-located (QCLed) for at least one of the following: Doppler shift, Doppler spread, average delay, delay spread, and spatial Rx parameter.

In some embodiments, the CSI reporting setting includes a plurality of periodic CSI resource settings, where the plurality of periodic CSI resource settings includes a plurality of CSI-RS resource sets with each periodic CSI resource setting including one CSI-RS resource set. In some embodiments, CSI-RS resources included in the plurality of CSI-RS resource sets are configured with a same periodicity. In some embodiments, CSI-RS resources included in the plurality of CSI-RS resource sets are configured with a list of time offsets, where the list of time offsets are based on at least one of a periodicity, a predefined value, and a number of the plurality of periodic CSI resource settings. In some embodiments, the CSI triggering state list includes a triggering set configured to link the CSI reporting setting and the plurality of CSI-RS resource sets. In some embodiments, the plurality of CSI-RS resource sets are configured to be quasi co-located (QCLed) with a same synchronization signal block (SSB) for at least one of the following: Doppler shift, average delay, and spatial Rx parameter. In some embodiments, all CSI-RS resources associated with the CSI reporting setting are quasi co-located (QCLed) for at least one of the following: Doppler shift, Doppler spread, average delay, delay spread, and spatial Rx parameter.

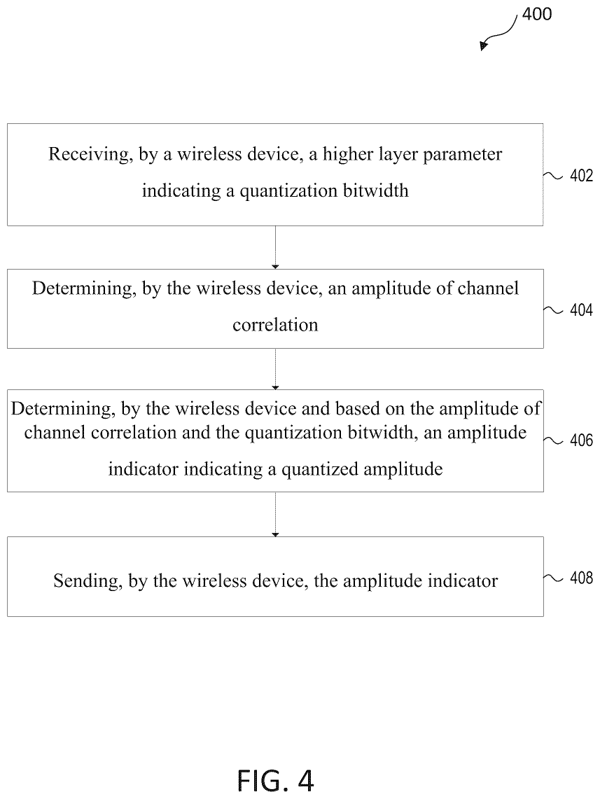

FIG. 4 is an exemplary flowchart for sending an amplitude indicator. Operation 402 includes receiving, by a wireless device, a higher layer parameter indicating a quantization bitwidth. Operation 404 includes determining, by the wireless device, an amplitude of channel correlation. Operation 406 includes determining, by the wireless device and based on the amplitude of channel correlation and the quantization bitwidth, an amplitude indicator indicating a quantized amplitude. Operation 408 includes sending, by the wireless device, the amplitude indicator. In some embodiments, the method can be implemented according to Embodiments 1-3. In some embodiments, performing further steps of the method can be based on a better system performance than a legacy protocol.

In some embodiments, a range of the quantized amplitude is from 0 to 1. In some embodiments, the quantization bitwidth is 3, 4, or 5. In some embodiments, a quantization granularity increases as the amplitude of channel correlation decreases. In some embodiments, a quantization granularity increases exponentially or linearly as the amplitude of channel correlation decreases. In some embodiments, the quantization bitwidth is 3, and the amplitude indicator k and the quantized amplitude of channel correlation have a mapping relationship. In some embodiments, the mapping relationship between the amplitude indicator k and the quantized amplitude of channel correlation is associated with at least one of the following: one over 2^{k}, square root of one over 2^{k}, fourth root of one over 2^{k}, eighth root of one over 2^{k}, k/8, k/16, and k/32. In some embodiments, the quantization bitwidth is 4, and the amplitude indicator k and the quantized amplitude of channel correlation have a mapping relationship. In some embodiments, the mapping relationship is associated with at least one of the following: square root of one over 2^{k}, fourth root of one over 2^{k}, and power of k/16. In some embodiments, the amplitude indicator and the amplitude of channel correlation have a first mapping relationship when the quantization bitwidth is 3, and the amplitude indicator and the amplitude of channel correlation have a second mapping relationship when the quantization bitwidth is 4, where the first and second mapping relationships are different.

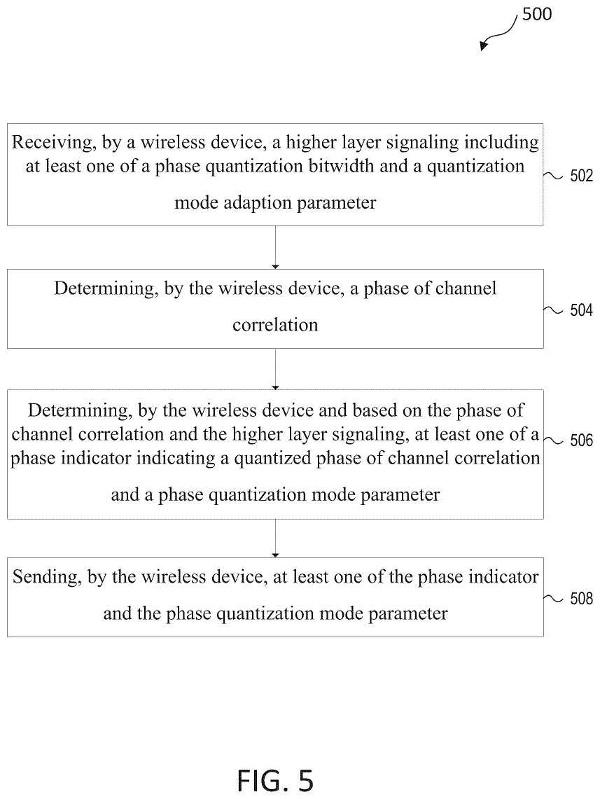

FIG. 5 is an exemplary flowchart for sending a phase indicator. Operation 502 includes receiving, by a wireless device, a higher layer signaling including at least one of a phase quantization bitwidth and a quantization mode adaption parameter. Operation 504 includes determining, by the wireless device, a phase of channel correlation. Operation 506 includes determining, by the wireless device and based on the phase of channel correlation and the higher layer signaling, at least one of a phase indicator indicating a quantized phase of channel correlation and a phase quantization mode parameter. Operation 508 includes sending, by the wireless device, at least one of the phase indicator and the phase quantization mode parameter. In some embodiments, the method can be implemented according to Embodiments 1-3. In some embodiments, performing further steps of the method can be based on a better system performance than a legacy protocol.

In some embodiments, a range of the quantized phase is from 0 to 2π. In some embodiments, the range of the quantized phase is determined by at least one of the following: 2π and an amplitude of channel correlation. In some embodiments, the quantization bitwidth is 3 or 4. In some embodiments, a quantization granularity stays consistent within a range of the quantized phase. In some embodiments, the quantization bitwidth is 3, and the phase indicator 1 and the quantized phase of channel correlation have a mapping relationship. In some embodiments, the mapping relationship is associated with 1*π/4. In some embodiments, the quantization bitwidth is 4, and the phase indicator 1 and the quantized phase of channel correlation have a mapping relationship. In some embodiments, the mapping relationship is associated with 1*π/8. In some embodiments, the phase indicator and the phase of channel correlation have a first mapping relationship when the quantization bitwidth is 3, and the phase indicator and the phase of channel correlation have a second mapping relationship when the quantization bitwidth is 4, where the first and second mapping relationships are different.

In some embodiments, the method further includes determining, by the wireless device, a value of the phase quantization mode parameter. In some embodiments, the value of the phase quantization mode parameter is 0 or 1. In some embodiments, the value of the phase quantization mode parameter is 0, indicating that a quantization granularity increases as the phase of channel correlation increases. In some embodiments, the quantization granularity increases exponentially or linearly as the phase of channel correlation increases. In some embodiments, the value of the phase quantization mode parameter is 1, indicating that a quantization granularity decreases as the phase of channel correlation increases. In some embodiments, the quantization granularity decreases exponentially or linearly as the phase of channel correlation increases. In some embodiments, the value of the phase quantization mode parameter is 0 and the quantization bitwidth is 3, and the phase indicator and the phase of channel correlation have a mapping relationship. In some embodiments, the mapping relationship between the phase indicator 1 and the quantized phase of channel correlation is associated with at least one of the following: 2π, one over 2^{l}, square root of one over 2^{l}, ⅛, and 1/16. In some embodiments, the value of the phase quantization mode parameter is 0 and the quantization bitwidth is 4, and the phase indicator 1 and the quantized phase of channel correlation have a mapping relationship. In some embodiments, the mapping relationship is associated with at least one of the following: 2π, square root of one over 2^{l}, and power of 1/16. In some embodiments, the phase indicator and the phase of channel correlation have a first mapping relationship when the value of the phase quantization mode parameter is 0 and the quantization bitwidth is 3, and the phase indicator and the phase of channel correlation have a second mapping relationship when the value of the phase quantization mode parameter is 0 and the quantization bitwidth is 4, where the first and second mapping relationships are different.

In some embodiments, the higher layer signaling includes the phase quantization bitwidth, where a mapping between the phase indicator and the quantized phase of channel correlation is determined by at least one of the phase quantization bitwidth and the phase quantization mode parameter. In some embodiments, the higher layer signaling includes the phase quantization bitwidth and the quantization mode adaption parameter, where the quantization mode adaption parameter is set as “on,” and where a mapping between the phase indicator and the quantized phase of channel correlation is determined by the phase quantization bitwidth and the quantization mode adaption parameter. In some embodiments, the higher layer signaling includes the phase quantization bitwidth and the quantization mode adaption parameter, where the quantization mode adaption parameter is set as “off,” and where a mapping between the phase indicator and the quantized phase of channel correlation is determined by the phase quantization bitwidth. In some embodiments, a mapping relationship between the phase indicator 1 and the quantized phase of channel correlation is associated with at least one of the following: 2π, one over 2^{l}, square root of one over 2^{l}, 1/7, ⅛, 1/15, and 1/16.

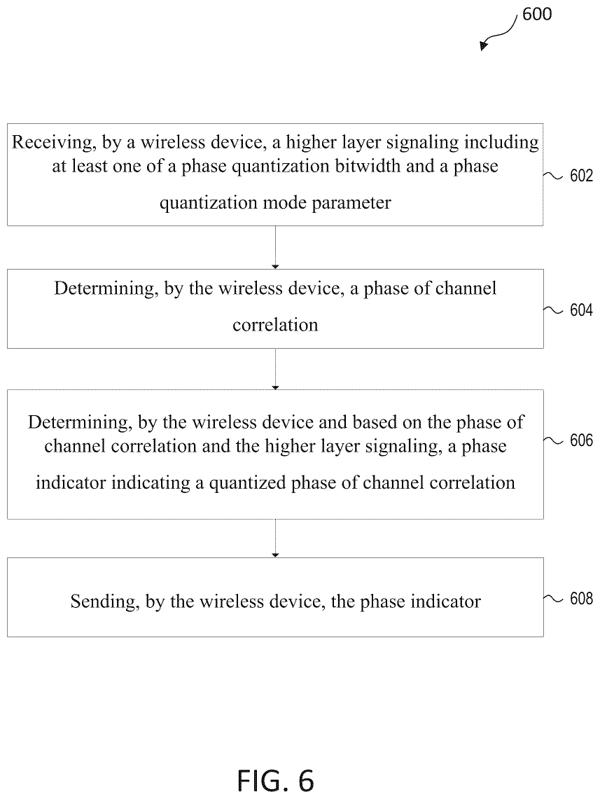

FIG. 6 is another exemplary flowchart for sending a phase indicator. Operation 602 includes receiving, by a wireless device, a higher layer signaling including at least one of a phase quantization bitwidth and a phase quantization mode parameter. Operation 604 includes determining, by the wireless device, a phase of channel correlation. Operation 606 includes determining, by the wireless device and based on the phase of channel correlation and the higher layer signaling, a phase indicator indicating a quantized phase of channel correlation. Operation 608 includes sending, by the wireless device, the phase indicator. In some embodiments, the method can be implemented according to Embodiments 1-3. In some embodiments, performing further steps of the method can be based on a better system performance than a legacy protocol.

In some embodiments, a mapping between the phase indicator and the quantized phase of channel correlation is determined by at least one of the phase quantization bitwidth and the phase quantization mode parameter. In some embodiments, a mapping relationship between the phase indicator 1 and the quantized phase of channel correlation is associated with at least one of the following: 2π, one over 2^{l}, square root of one over 2^{l}, 1/7, ⅛, 1/15, and 1/16.

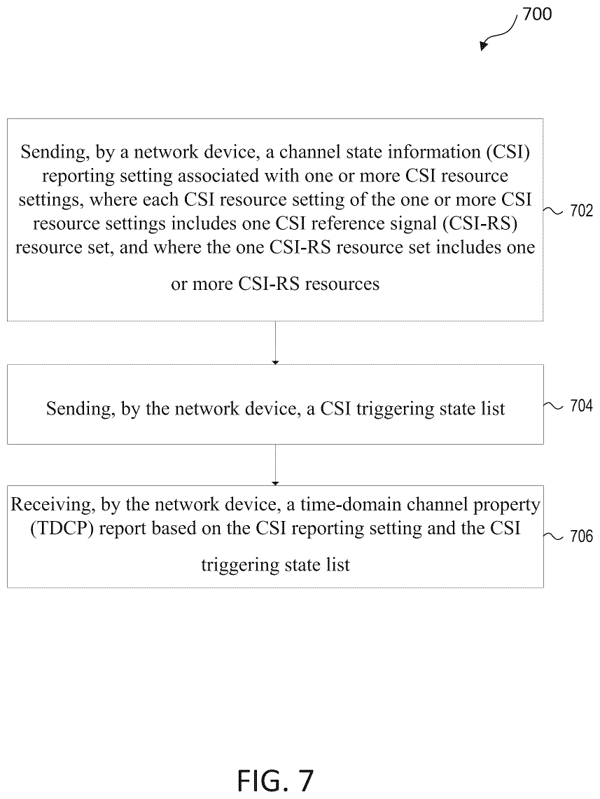

FIG. 7 is an exemplary flowchart for receiving a TDCP report. Operation 702 includes sending, by a network device, a channel state information (CSI) reporting setting associated with one or more CSI resource settings, where each CSI resource setting of the one or more CSI resource settings includes one CSI reference signal (CSI-RS) resource set, and where the one CSI-RS resource set includes one or more CSI-RS resources. Operation 704 includes sending, by the network device, a CSI triggering state list. Operation 706 includes receiving, by the network device, a time-domain channel property (TDCP) report based on the CSI reporting setting and the CSI triggering state list. In some embodiments, the method can be implemented according to Embodiments 1-3. In some embodiments, performing further steps of the method can be based on a better system performance than a legacy protocol.

In some embodiments, the CSI reporting setting is associated with an aperiodic CSI resource setting, where the aperiodic CSI resource setting includes a CSI-RS resource set. In some embodiments, the CSI triggering state list includes a triggering state configured to link the CSI reporting setting and the CSI-RS resource set. In some embodiments, the CSI-RS resource set is configured to be quasi co-located (QCLed) with a synchronization signal block (SSB) for at least one of the following: Doppler shift, average delay, and spatial Rx parameter. In some embodiments, all CSI-RS resources associated with the CSI reporting setting are quasi co-located (QCLed) for at least one of the following: Doppler shift, Doppler spread, average delay, delay spread, and spatial Rx parameter.

In some embodiments, the CSI reporting setting is associated with two aperiodic CSI resource settings, where the two aperiodic CSI resource settings include two CSI-RS resource sets with each aperiodic CSI resource setting including one CSI-RS resource set. In some embodiments, the two CSI-RS resource sets include a same number of CSI-RS resources. In some embodiments, the two CSI-RS resource sets are configured with different triggering time offsets. In some embodiments, the CSI triggering state list includes a triggering set configured to link the CSI reporting setting and the two CSI-RS resource sets. In some embodiments, the two CSI-RS resource sets are configured to be quasi co-located (QCLed) with a same synchronization signal block (SSB) for at least one of the following: Doppler shift, average delay, and spatial Rx parameter. In some embodiments, all CSI-RS resources associated with the CSI reporting setting are quasi co-located (QCLed) for at least one of the following: Doppler shift, Doppler spread, average delay, delay spread, and spatial Rx parameter.

In some embodiments, the CSI reporting setting is associated with an aperiodic CSI resource setting and a periodic CSI resource setting, where the aperiodic CSI resource setting includes a first CSI-RS resource set, and where the periodic CSI resource setting includes a second CSI-RS resource set. In some embodiments, the first and second CSI-RS resource sets include a same number of CSI-RS resources. In some embodiments, CSI-RSs associated with the aperiodic CSI resource setting and CSI-RSs associated with the periodic CSI resource setting are not to be transmitted or received in overlapping slots. In some embodiments, the CSI triggering state list includes a triggering set configured to link the CSI reporting setting and the first and second CSI-RS resource sets. In some embodiments, the second CSI-RS resource set is configured to be quasi co-located (QCLed) with a synchronization signal block (SSB) for at least one of the following: Doppler shift, average delay, and spatial Rx parameter. In some embodiments, the first CSI-RS resource set is configured to be quasi co-located (QCLed) with the second CSI-RS resource set for at least one of the following: Doppler shift, Doppler spread, average delay, delay spread, and spatial Rx parameter. In some embodiments, all CSI-RS resources associated with the CSI reporting setting are quasi co-located (QCLed) for at least one of the following: Doppler shift, Doppler spread, average delay, delay spread, and spatial Rx parameter.

In some embodiments, the CSI reporting setting is associated with a periodic CSI resource setting, where the periodic CSI resource setting includes a CSI-RS resource set. In some embodiments, the CSI triggering state list includes a triggering state configured to link the CSI reporting setting and the CSI-RS resource set. In some embodiments, the CSI-RS resource set is configured to be quasi co-located (QCLed) with a synchronization signal block (SSB) for at least one of the following: Doppler shift, average delay, and spatial Rx parameter. In some embodiments, all CSI-RS resources associated with the CSI reporting setting are quasi co-located (QCLed) for at least one of the following: Doppler shift, Doppler spread, average delay, delay spread, and spatial Rx parameter.

In some embodiments, the CSI reporting setting is associated with a first periodic CSI resource setting and a second periodic CSI resource setting, where the first periodic CSI resource setting includes a first CSI-RS resource set, and where the second periodic CSI resource setting includes a second CSI-RS resource set. In some embodiments, CSI-RS resources included in the first CSI-RS resource set are configured with a first periodicity, and CSI-RS resources included in the second CSI-RS resource set are configured with a second periodicity, where the first and second periodicities have a mapping relationship. In some embodiments, CSI-RS resources included in the first CSI-RS resource set are configured with a first periodicity, and CSI-RS resources included in the second CSI-RS resource set are configured with a second periodicity, where the second periodicity is obtained by multiplying the first periodicity by an integer equal to or greater than 1. In some embodiments, CSI-RS resources included in the first and second CSI-RS resource sets are configured with different triggering time offsets. In some embodiments, CSI-RS resources included in the first and second CSI-RS resource sets are not to be transmitted or received in overlapping slots. In some embodiments, the CSI triggering state list includes a triggering set configured to link the CSI reporting setting and the first and second CSI-RS resource sets. In some embodiments, the first and second CSI-RS resource sets are configured to be quasi co-located (QCLed) with a same synchronization signal block (SSB) for at least one of the following: Doppler shift, average delay, and spatial Rx parameter. In some embodiments, all CSI-RS resources associated with the CSI reporting setting are quasi co-located (QCLed) for at least one of the following: Doppler shift, Doppler spread, average delay, delay spread, and spatial Rx parameter.

In some embodiments, the CSI reporting setting includes a plurality of periodic CSI resource settings, where the plurality of periodic CSI resource settings includes a plurality of CSI-RS resource sets with each periodic CSI resource setting including one CSI-RS resource set. In some embodiments, CSI-RS resources included in the plurality of CSI-RS resource sets are configured with a same periodicity. In some embodiments, CSI-RS resources included in the plurality of CSI-RS resource sets are configured with a list of time offsets, where the list of time offsets are based on at least one of a periodicity, a predefined value, and a number of the plurality of periodic CSI resource settings. In some embodiments, the CSI triggering state list includes a triggering set configured to link the CSI reporting setting and the plurality of CSI-RS resource sets. In some embodiments, the plurality of CSI-RS resource sets are configured to be quasi co-located (QCLed) with a same synchronization signal block (SSB) for at least one of the following: Doppler shift, average delay, and spatial Rx parameter. In some embodiments, all CSI-RS resources associated with the CSI reporting setting are quasi co-located (QCLed) for at least one of the following: Doppler shift, Doppler spread, average delay, delay spread, and spatial Rx parameter.

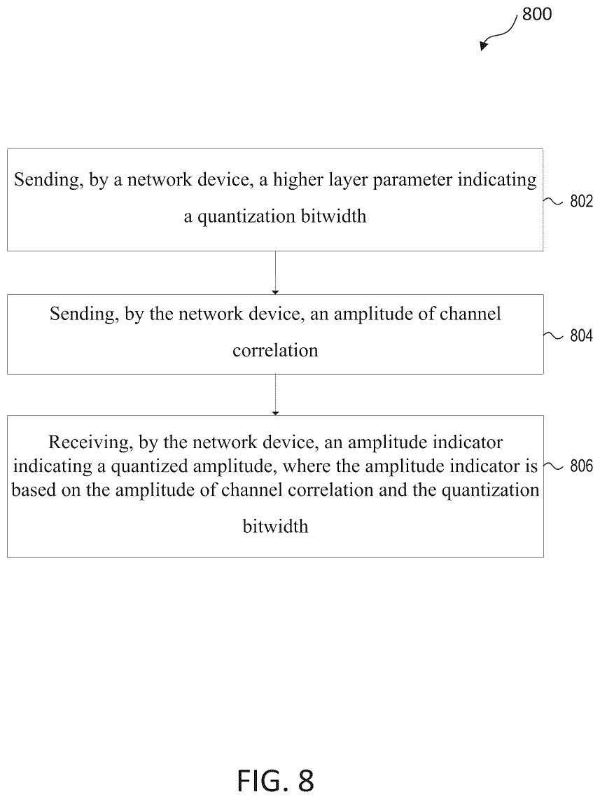

FIG. 8 is an exemplary flowchart for receiving an amplitude indicator. Operation 802 includes sending, by a network device, a higher layer parameter indicating a quantization bitwidth. Operation 804 includes sending, by the network device, an amplitude of channel correlation. Operation 806 includes receiving, by the network device, an amplitude indicator indicating a quantized amplitude, where the amplitude indicator is based on the amplitude of channel correlation and the quantization bitwidth. In some embodiments, the method can be implemented according to Embodiments 1-3. In some embodiments, performing further steps of the method can be based on a better system performance than a legacy protocol.

In some embodiments, a range of the quantized amplitude is from 0 to 1. In some embodiments, the quantization bitwidth is 3, 4, or 5. In some embodiments, a quantization granularity increases as the amplitude of channel correlation decreases. In some embodiments, a quantization granularity increases exponentially or linearly as the amplitude of channel correlation decreases. In some embodiments, the quantization bitwidth is 3, and the amplitude indicator and the amplitude of channel correlation have a mapping relationship. In some embodiments, the mapping relationship between the amplitude indicator k and the quantized amplitude of channel correlation is associated with at least one of the following: one over 2^{k}, square root of one over 2^{k}, fourth root of one over 2^{k}, eighth root of one over 2^{k}, k/8, k/16, and k/32. In some embodiments, the quantization bitwidth is 4, and the amplitude indicator k and the quantized amplitude of channel correlation have a mapping relationship. In some embodiments, the mapping relationship is associated with at least one of the following: square root of one over 2^{k}, fourth root of one over 2^{k}, and power of k/16. In some embodiments, the amplitude indicator and the amplitude of channel correlation have a first mapping relationship when the quantization bitwidth is 3, and the amplitude indicator and the amplitude of channel correlation have a second mapping relationship when the quantization bitwidth is 4, where the first and second mapping relationships are different.

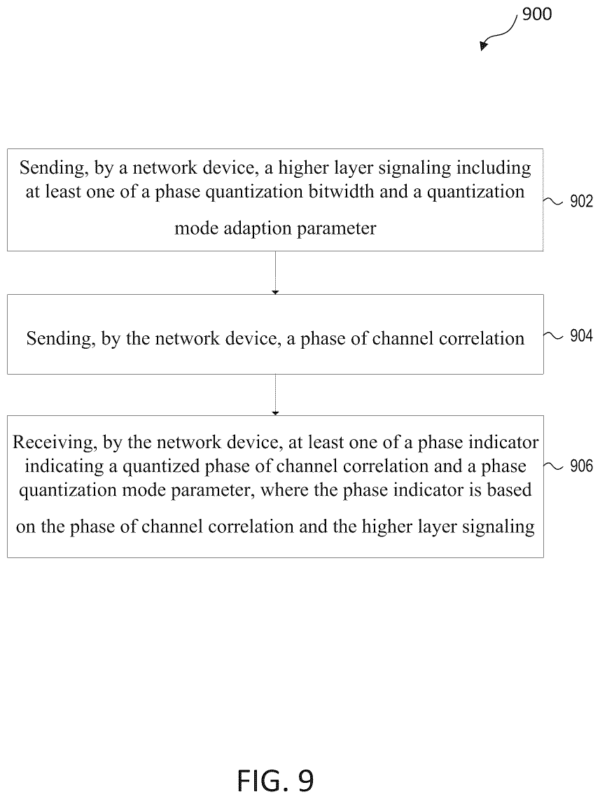

FIG. 9 is an exemplary flowchart for receiving a phase indicator. Operation 902 includes sending, by a network device, a higher layer signaling including at least one of a phase quantization bitwidth and a quantization mode adaption parameter. Operation 904 includes sending, by the network device, a phase of channel correlation. Operation 906 includes receiving, by the network device, at least one of a phase indicator indicating a quantized phase of channel correlation and a phase quantization mode parameter, where the phase indicator is based on the phase of channel correlation and the higher layer signaling. In some embodiments, the method can be implemented according to Embodiments 1-3. In some embodiments, performing further steps of the method can be based on a better system performance than a legacy protocol.

In some embodiments, a range of the quantized phase is from 0 to 271. In some embodiments, the range of the quantized phase is determined by at least one of the following: 2π and an amplitude of channel correlation. In some embodiments, the quantization bitwidth is 3 or 4. In some embodiments, a quantization granularity stays consistent within a range of the quantized phase. In some embodiments, the quantization bitwidth is 3, and the phase indicator 1 and the quantized phase of channel correlation have a mapping relationship. In some embodiments, the mapping relationship is associated with 1*π/4. In some embodiments, the quantization bitwidth is 4, and the phase indicator 1 and the quantized phase of channel correlation have a mapping relationship. In some embodiments, the mapping relationship is associated with 1*π/8. In some embodiments, the phase indicator and the phase of channel correlation have a first mapping relationship when the quantization bitwidth is 3, and the phase indicator and the phase of channel correlation have a second mapping relationship when the quantization bitwidth is 4, where the first and second mapping relationships are different.

In some embodiments, the method further includes receiving, by the network device, a value of the phase quantization mode parameter. In some embodiments, the value of the phase quantization mode parameter is 0 or 1. In some embodiments, the value of the phase quantization mode parameter is 0, indicating that a quantization granularity increases as the phase of channel correlation increases. In some embodiments, the quantization granularity increases exponentially or linearly as the phase of channel correlation increases. In some embodiments, the value of the phase quantization mode parameter is 1, indicating that a quantization granularity decreases as the phase of channel correlation increases. In some embodiments, the quantization granularity decreases exponentially or linearly as the phase of channel correlation increases. In some embodiments, the value of the phase quantization mode parameter is 0 and the quantization bitwidth is 3, and the phase indicator 1 and the quantized phase of channel correlation have a mapping relationship. In some embodiments, the mapping relationship between the phase indicator 1 and the quantized phase of channel correlation is associated with at least one of the following: 2π, one over 2^{l}, square root of one over 2^{l}, ⅛, and 1/16. In some embodiments, the value of the phase quantization mode parameter is 0 and the quantization bitwidth is 4, and the phase indicator 1 and the quantized phase of channel correlation have a mapping relationship. In some embodiments, the mapping relationship is associated with at least one of the following: 2π, square root of one over 2^{l}, and power of 1/16. In some embodiments, the phase indicator and the phase of channel correlation have a first mapping relationship when the value of the phase quantization mode parameter is 0 and the quantization bitwidth is 3, and the phase indicator and the phase of channel correlation have a second mapping relationship when the value of the phase quantization mode parameter is 0 and the quantization bitwidth is 4, where the first and second mapping relationships are different.

In some embodiments, the higher layer signaling includes the phase quantization bitwidth, where a mapping between the phase indicator and the quantized phase of channel correlation is determined by at least one of the phase quantization bitwidth and the phase quantization mode parameter. In some embodiments, the higher layer signaling includes the phase quantization bitwidth and the quantization mode adaption parameter, where the quantization mode adaption parameter is set as “on,” and where a mapping between the phase indicator and the quantized phase of channel correlation is determined by the phase quantization bitwidth and the quantization mode adaption parameter. In some embodiments, the higher layer signaling includes the phase quantization bitwidth and the quantization mode adaption parameter, where the quantization mode adaption parameter is set as “off,” and where a mapping between the phase indicator and the quantized phase of channel correlation is determined by the phase quantization bitwidth. In some embodiments, a mapping relationship between the phase indicator 1 and the quantized phase of channel correlation is associated with at least one of the following: 2π, one over 2^{l}, square root of one over 2^{l}, 1/7, ⅛, 1/15, and 1/16.

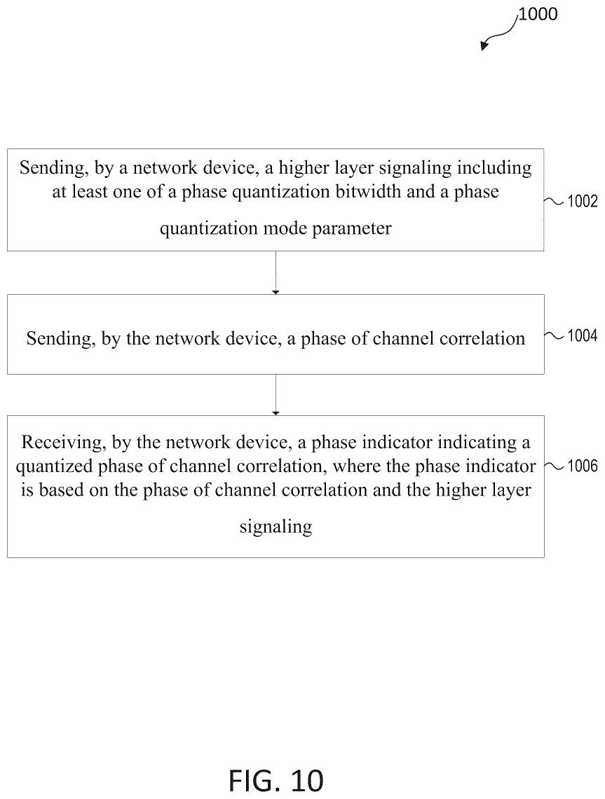

FIG. 10 is another exemplary flowchart for receiving a phase indicator. Operation 1002 includes sending, by a network device, a higher layer signaling including at least one of a phase quantization bitwidth and a phase quantization mode parameter. Operation 1004 includes sending, by the network device, a phase of channel correlation. Operation 1006 includes receiving, by the network device, a phase indicator indicating a quantized phase of channel correlation, where the phase indicator is based on the phase of channel correlation and the higher layer signaling. In some embodiments, the method can be implemented according to Embodiments 1-3. In some embodiments, performing further steps of the method can be based on a better system performance than a legacy protocol.

In some embodiments, a mapping between the phase indicator and the quantized phase of channel correlation is determined by at least one of the phase quantization bitwidth and the phase quantization mode parameter. In some embodiments, a mapping relationship between the phase indicator 1 and the quantized phase of channel correlation is associated with at least one of the following: 2π, one over 2^{l}, square root of one over 2^{l}, 1/7, ⅛, 1/15, and 1/16.

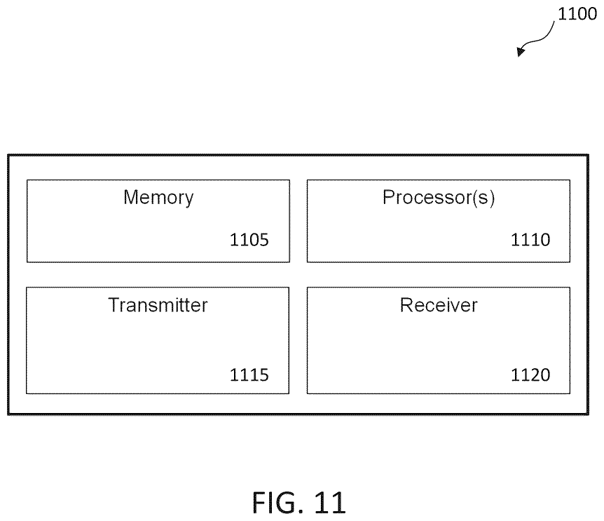

FIG. 11 shows an exemplary block diagram of a hardware platform 1100 that may be a part of a network device (e.g., base station) or a communication device (e.g., a user equipment (UE)). The hardware platform 1100 includes at least one processor 1110 and a memory 1105 having instructions stored thereupon. The instructions upon execution by the processor 1110 configure the hardware platform 1100 to perform the operations described in FIGS. 1 to 10 and in the various embodiments described in this patent document. The transmitter 1115 transmits or sends information or data to another device. For example, a network device transmitter can send a message to a user equipment. The receiver 1120 receives information or data transmitted or sent by another device. For example, a user equipment can receive a message from a network device. For example, a UE or a network device, as described in the present document, may be implemented using the hardware platform 1100.

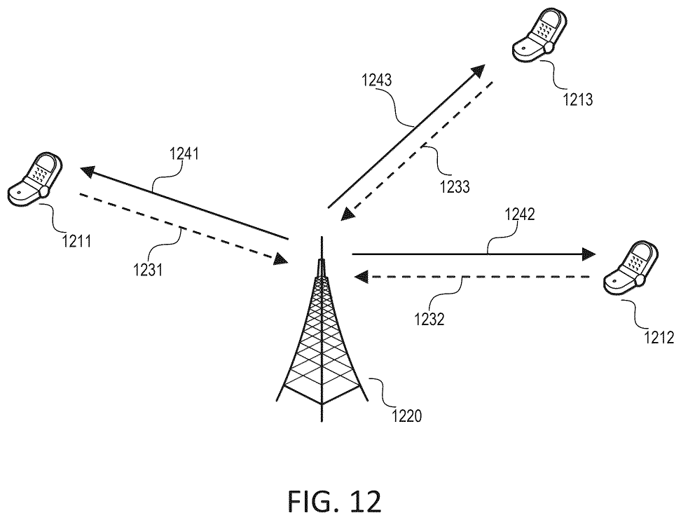

The implementations as discussed above will apply to a wireless communication. FIG. 12 shows an example of a wireless communication system (e.g., a 5G or NR cellular network) that includes a base station 1220 and one or more user equipment (UE) 1211, 1212 and 1213. In some embodiments, the UEs access the BS (e.g., the network) using a communication link to the network (sometimes called uplink direction, as depicted by dashed arrows 1231, 1232, 1233), which then enables subsequent communication (e.g., shown in the direction from the network to the UEs, sometimes called downlink direction, shown by arrows 1241, 1242, 1243) from the BS to the UEs. In some embodiments, the BS send information to the UEs (sometimes called downlink direction, as depicted by arrows 1241, 1242, 1243), which then enables subsequent communication (e.g., shown in the direction from the UEs to the BS, sometimes called uplink direction, shown by dashed arrows 1231, 1232, 1233) from the UEs to the BS. The UE may be, for example, a smartphone, a tablet, a mobile computer, a machine to machine (M2M) device, an Internet of Things (IoT) device, and so on. The UEs described in the present document may be communicatively coupled to the base station 1220 depicted in FIG. 12. The UEs can also communicate with BS for CSI communications.

It will be appreciated by one of skill in the art that the present document discloses methods to determine more accurate precoding matrices especially in the case where different frequency locations correspond to different precoding matrices while the overhead of reporting the precoding matrices by the UE (or informed by the base station) does not increase. More accurate channel state information can be obtained because of the more accurate precoding matrices. Then the spectrum efficiency is improved.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of wireless communication, comprising:
receiving, by a wireless device, a channel state information (CSI) reporting setting, wherein the CSI reporting setting is associated with two aperiodic CSI resource settings, wherein the two aperiodic CSI resource settings comprise two CSI-Reference Signal (RS) resource sets with each aperiodic CSI resource setting comprising a CSI-RS resource set, and wherein the two CSI-RS resource sets are configured to be quasi co-located (QCLed) with a same synchronization signal block (SSB) for at least one of the following: Doppler shift, average delay, or spatial Rx parameter;
sending, by the wireless device, a report based on the CSI reporting setting.

2. The method of claim 1, wherein the CSI reporting setting is associated with one or more CSI resource settings, wherein each CSI resource setting of the one or more CSI resource settings comprises one CSI-RS resource set, and wherein the one CSI-RS resource set comprises one or more CSI-RS resources.

3. The method of claim 1, comprising:
receiving, by the wireless device, a CSI triggering state list; and
determining, by the wireless device, a time-domain channel property (TDCP) based on the CSI reporting setting and the CSI triggering state list,
wherein the report is a TDCP report that comprises the TDCP.

4. The method of claim 3, wherein the CSI triggering state list comprises a triggering set configured to link the CSI reporting setting and the two CSI-RS resource sets.

5. The method of claim 3, wherein the CSI reporting setting is associated with an aperiodic CSI resource setting and a periodic CSI resource setting, wherein the aperiodic CSI resource setting comprises a first CSI-RS resource set, and wherein the periodic CSI resource setting comprises a second CSI-RS resource set.

6. The method of claim 5, wherein the first and second CSI-RS resource sets comprise a same number of CSI-RS resources.

7. The method of claim 5, wherein CSI-RSs associated with the aperiodic CSI resource setting and CSI-RSs associated with the periodic CSI resource setting are not to be transmitted or received in overlapping slots.

8. The method of claim 5, wherein the CSI triggering state list comprises a triggering set configured to link the CSI reporting setting and the first and second CSI-RS resource sets.

9. The method of claim 5, wherein the second CSI-RS resource set is configured to be quasi co-located (QCLed) with a synchronization signal block (SSB) for at least one of the following: Doppler shift, average delay, and spatial Rx parameter.

10. The method of claim 1, wherein the CSI reporting setting is associated with a first periodic CSI resource setting and a second periodic CSI resource setting, wherein the first periodic CSI resource setting comprises a first CSI-RS resource set, and wherein the second periodic CSI resource setting comprises a second CSI-RS resource set.

11. The method of claim 10, wherein CSI-RS resources comprised in the first CSI-RS resource set are configured with a first periodicity, wherein CSI-RS resources comprised in the second CSI-RS resource set are configured with a second periodicity, and wherein the second periodicity is obtained by multiplying the first periodicity by an integer equal to or greater than 1.

12. The method of claim 10, wherein CSI-RS resources comprised in the first and second CSI-RS resource sets are configured with a list of time offsets, and wherein the list of time offsets is based on at least one of the following: a periodicity of CSI-RS resources comprised in the first CSI-RS resource set, a predefined value, and a number of periodic CSI resource settings.

13. The method of claim 10, wherein the first and second CSI-RS resource sets are configured to be quasi co-located (QCLed) with a same synchronization signal block (SSB) for at least one of the following: Doppler shift, average delay, and spatial Rx parameter.

14. A method of wireless communication, comprising:
determining, by a wireless device, an amplitude indicator, k, indicating a quantized amplitude of channel correlation; and
sending, by the wireless device, the amplitude indicator, k,
wherein a mapping relationship between the amplitude indicator, k, and the quantized amplitude of channel correlation is associated with at least one of the following: one over 2^{k}, square root of one over 2^{k}, fourth root of one over 2^{k}, eighth root of one over 2^{k}, k/8, k/16, or k/32.

15. The method of claim 14, comprising:
receiving, by a wireless device, a higher layer parameter indicating a quantization bitwidth; and
determining, by the wireless device, an amplitude of channel correlation, wherein the amplitude indicator, k, is determined based on the amplitude of channel correlation and the quantization bitwidth.

16. The method of claim 15, wherein a quantization granularity increases as the amplitude of channel correlation decreases.

17. The method of claim 15, wherein a quantization granularity increases exponentially or linearly as the amplitude of channel correlation decreases.

18. A method of wireless communication, comprising:
determining, by a wireless device, a phase indicator, l, indicating a quantized phase of channel correlation; and
sending, by the wireless device, the phase indicator, l,
wherein a mapping relationship between the phase indicator, l, and the quantized phase of channel correlation is associated with at least one of the following: 2π, one over 2^{l}, square root of one over 2^{l}, 1/7, ⅛, 1/15, or 1/16, and wherein 1 is an integer.

19. The method of claim 18, comprising:
receiving, by a wireless device, a higher layer signaling comprising at least one of a phase quantization bitwidth and a phase quantization mode parameter; and
determining, by the wireless device, a phase of channel correlation,
wherein the phase indicator, l, is determined based on the phase of channel correlation and the higher layer signaling.

20. The method of claim 19, wherein the mapping relationship between the phase indicator and the quantized phase of channel correlation is determined by at least one of the phase quantization bitwidth or the phase quantization mode parameter.
